(19) United States
(12) Patent Application Publication
(10) Pub. No.: US 2011/0123075 A1
(43) Pub. Date: May 26, 2011

(54) SYSTEMS AND METHODS FOR MARKING A MEDICAL IMAGE WITH A DIGITAL INDICATOR

(75) Inventors: Yao Nie, Sunnyvale, CA (US); Chao Shi, San Jose, CA (US); Nariman Najdi-Nasab, San Jose, CA (US); Akira Hasegawa, Saratoga, CA (US)

(73) Assignee: FUJIFILM CORPORATION, Tokyo (JP)

(21) Appl. No.: 12/626,601

(22) Filed: Nov. 25, 2009

(51) Int. Cl. G06K 9/00; G09G 5/00

(52) U.S. Cl. 382/128; 345/632

(57) ABSTRACT

A system and method is provided for automatically detecting and marking a region of interest in a medical image. A region of interest is first identified in the medical image, such as a nipple of a breast region in a mammography image. The identified nipple is then marked with a digital indicator, such as a bright circle, so that a user viewing the image can easily identify the nipple. The digital indicator can be temporarily removed so that no portion of the region of interest is obscured by the digital indicator. A region of interest corresponding to another anatomical feature may also be marked, such as a pectoral muscle, which may be marked by placing a digital outline around the border of the pectoral muscle. A user viewing the medical image with the digital indicators can easily identify the marked regions of interest.

### BACKGROUND

1. Field

The systems and methods described below relate to automatically identifying and marking a region of interest on a medical image, and more specifically to automatically identifying and marking an anatomical feature in a mammography image using a digital indicator.

2. Background

Medical imaging is the field of creating images of the human body for medical purposes, such as diagnosing or examining disease or other physiological anomalies. Numerous types of image modalities produce medical images, such as magnetic resonance imaging (MRI), radiography (x-rays), computed tomography (CT), ultrasound (US) and others. In medical imaging, an object of interest is usually selected pertaining to an area of the human body, such as the head, heart or chest.

One type of medical imaging is mammography, which is the examination of a medical image of the human breast. Mammography is used to detect breast cancer by examining the breast tissue for abnormalities such as microcalcifications or uncharacteristic masses.

In the process of reading digital mammography images, a user, such as a radiologist, often needs to identify the nipple of the breast, as the nipple is an important land marker in reviewing a breast. The nipple does not always appear prominently in the mammography image. To more easily detect the nipple, a mammography technician that is performing the mammography will place a physical marker on the nipple of the patient before taking the mammography image. When the mammography image is taken, the physical marker will show up as an extremely bright dot in the image. Placing the physical marker on the patient is time consuming, which affects the work flow of the technician. In addition, the brightness of the physical marker on the image is visually distracting and may even block out tissue that may be of interest to the radiologist.

Thus, it is desired to develop systems and methods for improving the process of identifying the nipple and reducing the visual impediments caused by the physical marker.

### SUMMARY

Various embodiments of the invention relate to systems and methods for marking a region of interest in a medical image with a digital indicator. A region of interest is first identified in the medical image, such as a nipple of a breast region in a mammography image. The identified nipple is then marked with a digital indicator, such as a bright circle, so that a user viewing the image can easily identify the nipple. The medical image with the marked region of interest is then displayed to a user.

Certain embodiments of the invention relate to a method for marking a medical image, comprising automatically identifying at least one region of interest in a medical image; marking the at least one region of interest with a digital indictor; and displaying the medical image with the marked region of interest on a display.

In another embodiment of the invention, the region of interest is automatically marked.

In another embodiment of the invention, the region of interest is automatically identified using a border detection algorithm.

In another embodiment of the invention, the region of interest is human tissue.

In another embodiment of the invention, the region of interest is an anatomical region of a breast region which is a portion of the breast region.

In another embodiment of the invention, the region of interest is a nipple.

In another embodiment of the invention, the region of interest to be automatically identified is selected by a user.

In another embodiment of the invention, the digital indicator is marked on approximately a center of the region of interest.

In another embodiment of the invention, the digital indicator is marked on approximately a border of the region of interest.

In another embodiment of the invention, further comprising the user temporarily removing the digital indicator from the medical image

Embodiments of the invention also relate to a system for marking a medical image, comprising an identifying unit which identifies at least one region of interest in the medical image; a marking unit which marks the at least one region of interest with a digital indicator; and a display unit which displays the medical image with the marked region of interest on a display.

In another embodiment of the invention, the system further comprises a display unit which displays the medical image with the marked region of interest on a display.

In another embodiment of the invention, the marking unit automatically marks the region of interest.

In another embodiment of the invention, the identifying unit automatically identifies a region of interest using a border detection algorithm.

In another embodiment of the invention, the region of interest is human tissue.

In another embodiment of the invention, the region of interest is an anatomical region of a breast region.

In another embodiment of the invention, the region of interest is a nipple.

In another embodiment of the invention, a type of region of interest to be identified by the identifying unit is selected by a user.

In another embodiment of the invention, the marking unit marks a digital indicator on approximately a center of the region of interest.

In another embodiment of the invention, the marking unit marks a digital indicator on approximately a border of the region of interest.

In another embodiment of the invention, the user may temporarily remove the digital indicator from the medical image.

Embodiments of the invention also relate to a computer program product for marking a region of interest a medical image, the computer program product embodied on a computer readable medium and when executed by a computer, performs the method comprising: automatically identifying at least one region of interest in a medical image; marking the at least one region of interest in the medical image with a digital indicator; and displaying the medical image with the marked region of interest on a display.

Additional embodiments related to the invention will be set forth in part in the description which follows, and in part will be apparent from the description, or may be learned by practice of the invention. Embodiments of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify various embodiments of the present invention and, together with the description, serve to explain and illustrate principles of the inventive technique. Specifically:

FIG. 1A depicts an unaltered mammography image showing a breast and a nipple area, as is known in the art;

FIG. 1B depicts an altered mammography image where the nipple area of the breast has been marked with a digital indicator, according to one embodiment of the invention;

FIG. 2A depicts an unaltered mammography image showing a breast and a pectoral muscle area, as is known in the art;

FIG. 2B depicts an altered mammography image where the pectoral muscle area of the breast has been marked with a digital indicator, according to one embodiment of the invention;

FIG. 3A depicts an unaltered mammography image showing a breast with a skin line, as is known in the art;

FIG. 3B depicts an altered mammography image where the skin line area of the breast has been marked with a digital indicator, according to one embodiment of the invention;

FIGS. 4A-4C depict methods of automatically detecting and marking a region of interest in a medical image, according to various embodiments of the invention;

FIG. 5 illustrates a system for automatically detecting and marking a region of interest in a medical image, according to one embodiment of the invention; and

FIG. 6 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

Various embodiments of the invention relate to systems and methods for automatically identifying and marking a region of interest a medical image, and more specifically to automatically identifying and marking an anatomical feature in a mammography image using a digital indicator. At least one region of interest in a medical image is identified, after which the region of interest is marked with a digital indicator. The medical image with the marked region of interest is then displayed to a user.

By automatically identifying and marking a region of interest, the systems and methods described herein aid a user in identifying relevant anatomical features in the medical images and save the user significant time and effort that would otherwise be spent identifying and labeling the medical image manually. As a result, the overall work flow of medical image screening and diagnosis will be improved. Additionally, the systems and methods described herein are capable of easily removing the digital indicator, so that the digital indicator does not obscure any portion of the region of interest. The user viewing the medical image, for example a radiologist, can more quickly determine the location of certain anatomical features on the medical image, such as the nipple on a mammography image. Therefore, the user can more clearly view and more accurately identify any potential physiological abnormalities without being distracted by more permanent indicators that are currently in use.

The inventive systems and methods are applicable to many types of medical imaging, including but not limited to magnetic resonance imaging (MRI), radiography (x-rays), computed tomography (CT) and ultrasound (US).

The following illustrative embodiments pertain to mammography images, but one skilled in the art will appreciate that the methods and systems described herein can be applied to any medical image of any area of the body with a region of interest to a user. In any medical image, the inventive systems and methods allow the user to identify a region of interest and mark the region of interest with a digital indicator.

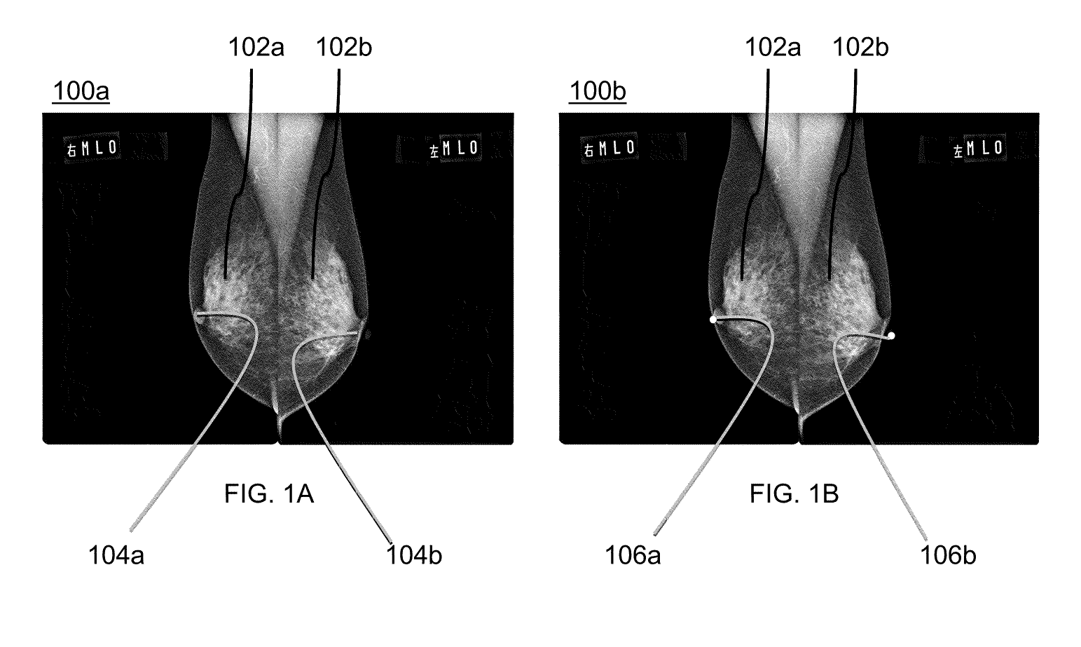

In one exemplary embodiment, a mammography image 100a depicts a right breast 102a, a left breast 102b, and right nipple area 104a and a left nipple area 104b, as shown in FIG. 1A. The mammography image 100a is actually two images—an image of a right breast 102a of a patient and an image of a left breast 102b of the patient, placed together in a back-to-back configuration for easy comparison. The user is interested in identifying the nipple areas 104a, 104b on the mammography image 100a. While the nipple area 104a of the right breast image 102a is fairly clear, the nipple area 104b of the left breast image 102b is not. The nipple areas 104a, 104b are automatically identified, as will be further described below, and then, as shown in FIG. 1B, the nipple areas 104a, 104b are marked with a digital indicator 106a, 106b; in this case, a white dot. The mammography image 100b with the digital indicator is then displayed to a user.

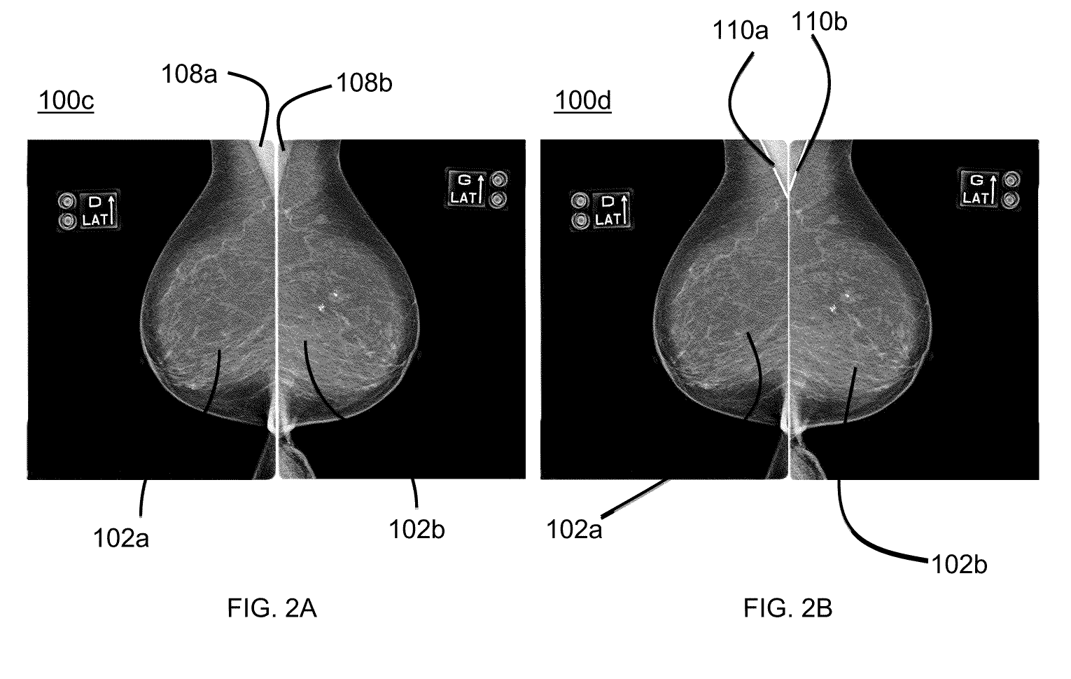

In another exemplary embodiment, a user is interested in identifying a pectoral muscle area 108a, 108b on the mammography image 100c, as depicted in FIG. 2A. The pectoral muscle area 108a, 108b is automatically identified, as will be further described below, and then, as shown in the mammography image 100d in FIG. 2B, the pectoral muscle area 108a, 108b is marked with a digital indicator 110a, 110b; in this case, a white line which separates the pectoral muscle from the rest of the breast. The mammography image with the digital indicator is then displayed to a user.

As the digital indicators 106a, 106b and 110a, 110b in FIGS. 1B and 2B are digital, a user viewing the image with a computer and a display may have the option to temporarily remove the indicator in order to view a portion of the medical image that is obscured by the digital indicator.

In one embodiment, identification of a region of interest in a medical image can be accomplished using a breast border and nipple position detection algorithm performed automatically by a computer. An exemplary breast border and nipple position detection algorithm is disclosed in “Automatic detection of the breast border and nipple position on digital mammograms using genetic algorithm for asymmetry approach to detection of microcalcifications,” Computer Methods and Programs in Biomedicine, Volume 87, Issue 1 (July 2007), Pages 12-20, incorporated herein in its entirety by reference. To identify the pectoral muscle area, an algorithm such as that discussed in “Radon-domain detection of the nipple and the pectoral muscle in mammograms,” J Digit Imaging, 2008 March; 21(1): 37-49, Epub, 2007 Apr. 11, the contents of which are incorporated by reference in its entirety, may be used.

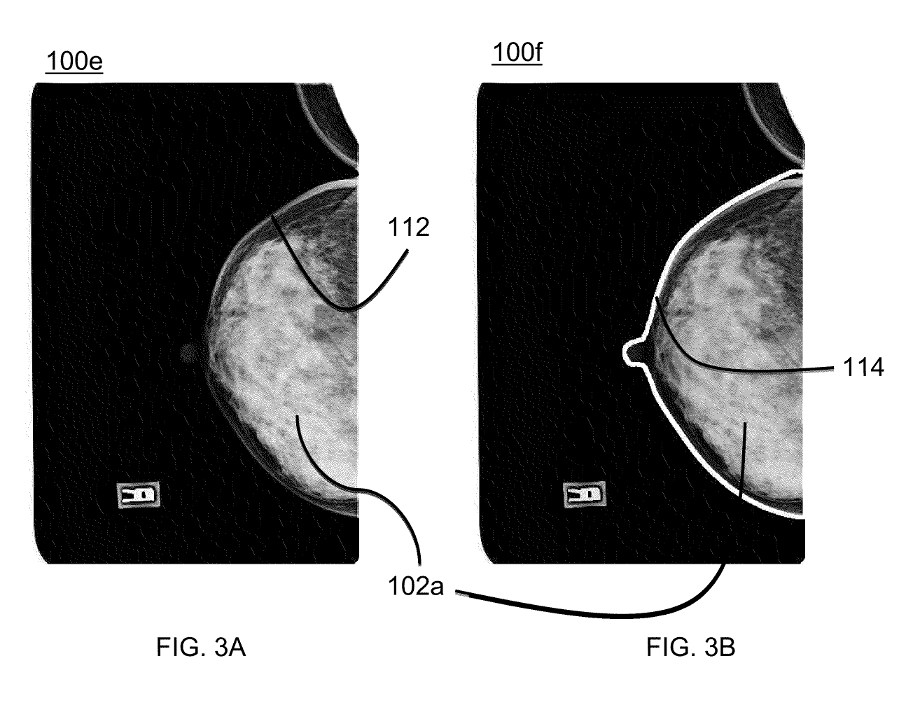

It will be appreciated by one of skill in the art, however, that the region of interest is not confined to a nipple area or a pectoral muscle area. Any anatomical region of the breast may be identified and marked as the region of interest, such as the skin line. As the skin line is a part of the breast border, the algorithm referenced above for automatic detection of the breast border will provide a digital indicator 114 for the skin line 112, as illustrated in the mammography images 100e and 100f in FIGS. 3A and 3B, respectively. In addition, the identification and marking of a region of interest can also be applied to medical images other than a mammography image in order to define regions of interest corresponding to other anatomical features or areas of the body. For example, medical images of humans or animals, including the brain, abdomen, arms or legs will all include anatomical features that may not be clear enough to define upon review of the original image. Further, a user may define an arbitrary region of interest for marking, for example by creating a window around the region of interest, selecting a predefined region of interest from a menu of commonly-used regions of interest, or tracing the region of interest using an input device on a computer.

In one embodiment, the marking of the region of interest is accomplished through software carried out by a computer. Image processing software may carry out algorithms to identify a desired region of interest, such as a nipple area, after which the software may create a digital indicator appropriate for labeling the region of interest. It will be appreciated that the shape, color, thickness and other features of the digital indicator may vary depending on the region of interest to be marked. As shown in FIG. 1B, a round, white circle may be appropriate to mark a nipple area, but in FIG. 2B, a thick line may be appropriate to mark a pectoral muscle area. The specific digital indicator may be predefined for the type of anatomical feature to be marked, or the user may select a preferred type of digital indicator depending on the region of interest to mark.

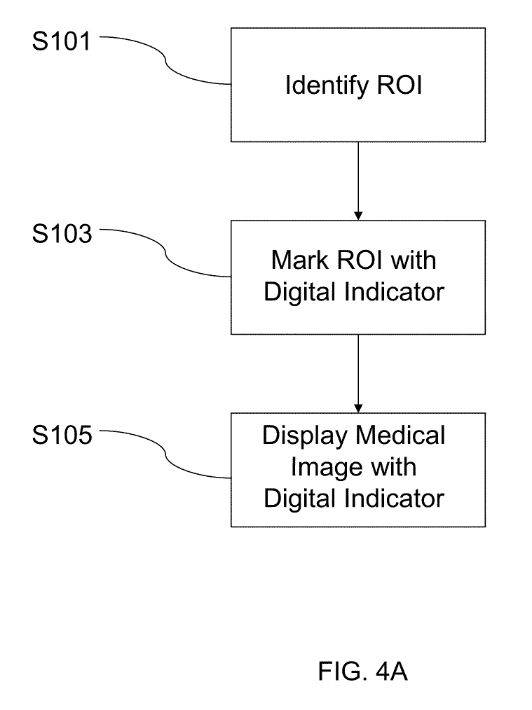

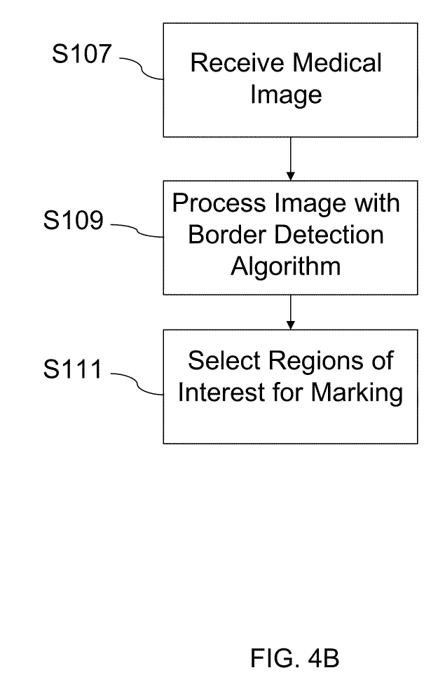

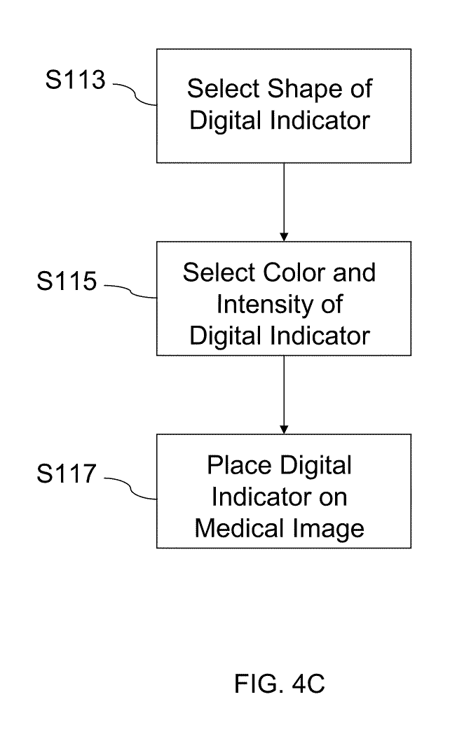

FIG. 4A depicts a flowchart for a method of identifying and marking a region of interest, according to one embodiment of the invention. In a first step S101, at least one region of interest (ROI) in a medical image is identified. In a second step S103, the at least one region of interest is marked with a digital indicator. Finally, in step S105, the medical image with the digital indicator is displayed.

FIG. 4B depicts one embodiment of more detailed steps of a method of identifying a region of interest, including a first step S107 of receiving a medical image at an image processor such as a computer. The medical image may be received directly from a medical imaging device such as an MRI, or the medical images could be stored after creation and inputted to a computer for processing at a later date. In a second step S109, the medical image is processed with a breast border and nipple position detection algorithm as referenced above, which detects, among other things, the position of the nipple area 104. In a next step S111, the identified nipple area is selected for marking with a digital indicator.

FIG. 4C depicts one embodiment of more detailed steps of a method for marking a region of interest with a digital indicator. In a first step S113, a shape of the digital indicator is selected based upon the type of region of interest identified. In a second step S115, the color and intensity of the digital indicator is selected based on the type of region of interest and the color and intensity of the entire medical image. For example, in a conventional medical image, the majority of the image is black, so that a digital indicator should be white in order to clearly stand out on the image. However, if a region of interest to be marked is bright and intense, the digital indicator could be dark, or a grayscale shade, in order to distinguish the digital indicator from the region of interest. In a third step S117, the digital indicator is placed on the image.

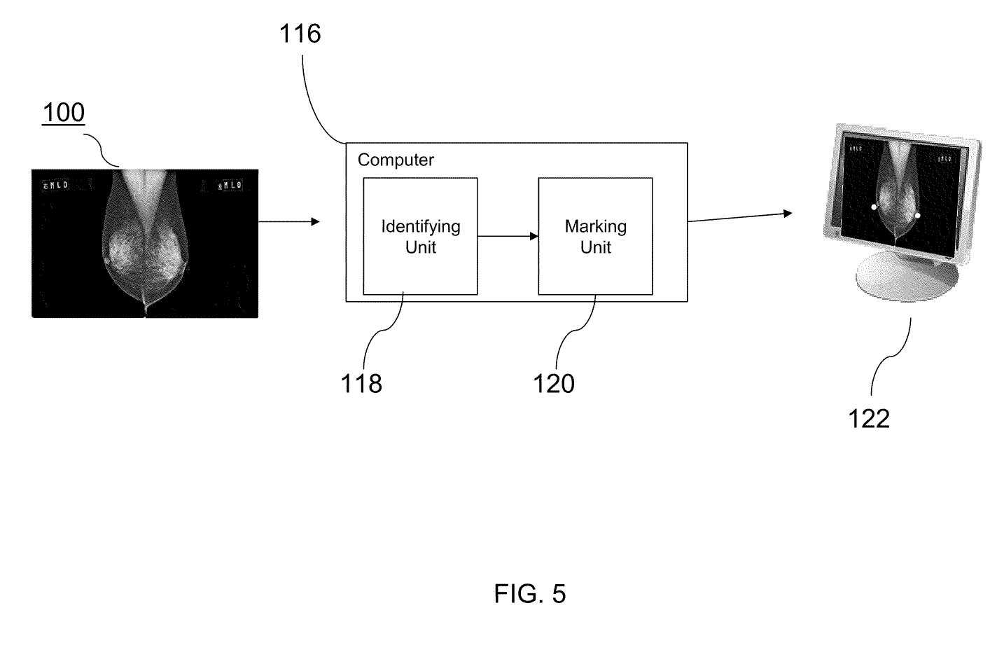

The inventive system may be implemented on a computer which receives the medical image and processes it according to the steps described above. The inventive system may be embodied as a computer program product or carried out by a combination of software and hardware. As illustrated in FIG. 5, an image 100 may be input to the computer 116 where an identifying unit 118 identifies the at least one region of interest in the medical image. A marking unit 120 then marks the region of interest with a digital indicator. Finally, a display unit 122 displays the medical image with the enhanced region of interest on a display for viewing by the user. In one non-limiting embodiment, the system provides the digital indicator as an option to the user, so that the user can remove the digital indicator to compare the marked medical image to the original unaltered image.

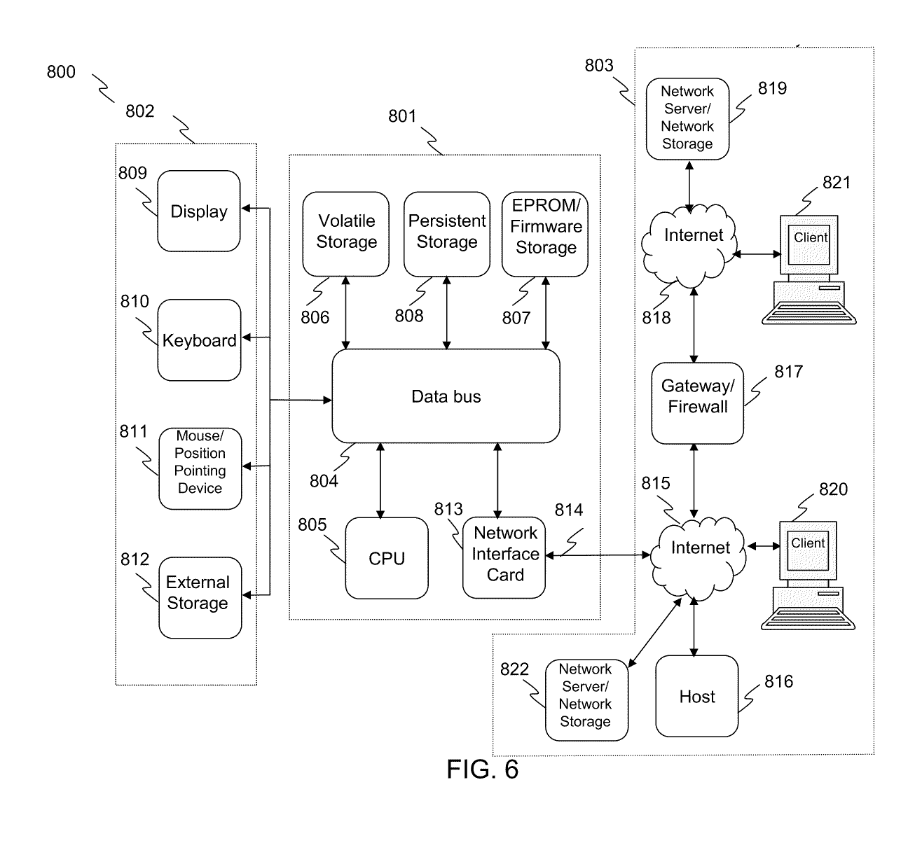

FIG. 6 is a block diagram that illustrates an embodiment of a computer/server system 800 upon which an embodiment of the inventive methodology may be implemented. The system 800 includes a computer/server platform 801, peripheral devices 802 and network resources 803.

The computer platform 801 may include a data bus 804 or other communication mechanism for communicating information across and among various parts of the computer platform 801, and a processor 805 coupled with bus 801 for processing information and performing other computational and control tasks. Computer platform 801 also includes a volatile storage 806, such as a random access memory (RAM) or other dynamic storage device, coupled to bus 804 for storing various information as well as instructions to be executed by processor 805. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 801 for storing information and instructions.

Computer platform 801 may be coupled via bus 804 to a display 809, such as a cathode ray tube (CRT), plasma display, or a liquid crystal display (LCD), for displaying information to a system administrator or user of the computer platform 801. An input device 820, including alphanumeric and other keys, is coupled to bus 801 for communicating information and command selections to processor 805. Another type of user input device is cursor control device 811, such as a mouse, a trackball, or cursor direction keys for communicating direction information and command selections to processor 804 and for controlling cursor movement on display 809. This input device typically has two degrees of freedom in two axes, a first axis (e.g., x) and a second axis (e.g., y), that allows the device to specify positions in a plane.

An external storage device 812 may be connected to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 808. Volatile media includes dynamic memory, such as volatile storage 806. Transmission media includes coaxial cables, copper wire and fiber optics, including the wires that comprise data bus 804.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is connected to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 813 typically provides data communication through one or more networks to other network resources. For example, network link 814 may provide a connection through local network 815 to a host computer 816, or a network storage/server 817. Additionally or alternatively, the network link 813 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 814 and communication interface 813. In the Internet example, when the system 801 acts as a network server, it might transmit a requested code or data for an application program running on client(s) 820 and/or 821 through Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution. In this manner, computer system 801 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the computerized storage system. It is intended that all matter contained in the above description or shown in the accompanying drawings shall be interpreted as illustrative only and not limiting.

What is claimed is:

1. A method for marking a region of interest in a medical image, the method comprising:
automatically identifying at least one region of interest in a medical image;
marking the at least one region of interest in the medical image with a digital indicator; and
displaying the medical image with the marked region of interest on a display.

2. The method of claim 1, wherein the region of interest is automatically marked.

3. The method of claim 2, wherein the region of interest is automatically identified using a border detection algorithm.

4. The method of claim 2, wherein the region of interest is human tissue.

5. The method of claim 4, wherein the region of interest is an anatomical region of a breast region which is a portion of the breast region.

6. The method of claim 5, wherein the region of interest is a nipple.

7. The method of claim 1, wherein the region of interest to be automatically identified is selected by a user.

8. The method of claim 1, wherein the digital indicator is marked on approximately a center of the region of interest.

9. The method of claim 1, wherein the digital indicator is marked on approximately a border of the region of interest.

10. The method of claim 8, further comprising the user temporarily removing the digital indicator from the medical image.

11. A system for marking a region of interest a medical image, the system comprising:
an identifying unit which automatically identifies at least one region of interest in a medical image; and
a marking unit which marks the at least one region of interest in the medical image with a digital indicator.

12. The system of claim 11, further comprising a display unit which displays the medical image with the marked region of interest on a display.

13. The system of claim 11, wherein the marking unit automatically marks the region of interest.

14. The system of claim 13, wherein the identifying unit automatically identifies a region of interest using a border detection algorithm.

15. The system of claim 13, wherein the region of interest is human tissue.

16. The system of claim 15, wherein the region of interest is an anatomical region of a breast region.

17. The system of claim 16, wherein the region of interest is a nipple.

18. The system of claim 11, wherein a type of region of interest to be identified by the identifying unit is selected by a user.

19. The system of claim 11, wherein the marking unit marks a digital indicator on approximately a center of the region of interest.

20. The system of claim 19, wherein the marking unit marks a digital indicator on approximately a border of the region of interest.

21. The system of claim 19, wherein the user may temporarily remove the digital indicator from the medical image.

22. A computer program product for marking a region of interest a medical image, the computer program product embodied on a computer readable medium and when executed by a computer, performs the method comprising:
automatically identifying at least one region of interest in a medical image;
marking the at least one region of interest in the medical image with a digital indicator; and
displaying the medical image with the marked region of interest on a display.
